(19) United States
(12) Patent Application Publication
(10) Pub. No.: US 2025/0373193 A1
(43) Pub. Date: Dec. 4, 2025

(54) WINDOW FOR A BUILDING OR STRUCTURE

(71) Applicant: ClearVue Technologies Ltd, West Perth, Western Australia (AU)

(72) Inventor: Mikhail Vasiliev, West Perth, Western Australia (AU)

(21) Appl. No.: 18/877,859

(22) PCT Filed: Jun. 21, 2023
(86) PCT No.: PCT/AU2023/050558

§ 371 Date: Dec. 20, 2024

(30) Foreign Application Priority Data
Jun. 21, 2022 (AU) 2022901699

(51) Int. Cl. H02S 20/26; E06B 9/24; H02S 40/20

(52) U.S. Cl. CPC H02S 20/26; E06B 9/24; H02S 40/20; E06B 2009/2476

(57) ABSTRACT

The disclosure provides a window for a building or structure. The window comprises a first panel being at least largely transmissive for visible light and having opposite first and second major surfaces. The first major surface is a light receiving surface. The first panel also includes a luminescent material and/or a light scattering material. The window also includes a plurality of solar cells facing the second major surface of the first panel and being positioned along and in proximity of an edge of the first panel, and a frame supporting the first panel directly or indirectly. The first major surface of the first panel is directly exposed to a space that is exterior to the window.

### FIELD OF THE INVENTION

The present disclosure relates to a window for a building or structure and relates particularly, though not exclusively, to a window which generates electricity.

### BACKGROUND OF THE INVENTION

Buildings such as office towers, high-rise housings and hotels use large amounts of exterior window panelling and/or facades which incorporate glass panelling.

Such glass panelling receives large amounts of sunlight, which results in heating of interior spaces requiring the use of air conditioners. A large amount of energy is globally used to operate air conditioners.

PCT international applications numbers PCT/AU2012/000778, PCT/AU2012/000787 and PCT/AU2014/000814 (owned by the present applicant) disclose a spectrally selective panel that may be used as a windowpane and that is transmissive for visible light, but has solar cell modules attached that absorb light, such as infrared and/or other re-emitted (internally wavelength-converted) radiation, to generate electricity.

The present invention provides further improvement.

### SUMMARY OF THE INVENTION

The present invention provides in a first aspect a window for a building or structure, the window comprising:
a first panel being at least largely transmissive for visible light and having opposite first and second major surfaces, the first major surface being a light receiving surface, the first panel comprising a luminescent material and/or a light scattering material;
a plurality of solar cells facing the second major surface of the first panel and being positioned along and in the proximity of an edge of the first panel; and
a frame supporting the first panel directly or indirectly;
wherein the first major surface of the first panel is directly exposed to a space that is exterior to the window.

The first panel of the window is positioned such that light originating from the outside of the building or structure is received by the receiving surface of the first panel before transmitting to other portions of the window.

The plurality of solar cells may face the second major surface of the first panel directly. The solar cells may be parallel to the second surface or may be positioned at an inclined orientation relative to the second major surface.

In one embodiment the first panel comprises parallel first and second panel portions which may be laminated together.

The first major surface may be a surface of the first panel portion and the second major surface may be a surface of the second panel portion. The first and second panel portions may be laminated together using a sandwich layer including ethylene-vinyl acetate (EVA) or another suitable material.

The luminescent material may be embedded in the sandwich layer. The sandwich layer may comprise polyvinyl butyral (PVB). In one specific example the luminescent material may be embedded in the PVB and may comprise inorganic luminophore material.

The fluorescence radiation emitted by the luminescent material(s) is directed in random directions and a portion of the emitted fluorescence radiation is directed towards an edge portion of the first panel (for example by total internal reflection within the first panel or by reflection at other surfaces of the window) where a portion of the light can be absorbed by the solar cells for generation of electricity. As the first panel directly faces a space that is outside of the window, the luminescence material is positioned near the outside of the window thereby avoiding intensity losses that incident light would otherwise experience when transmitting through multiple panels, such as glass panels, before reaching the luminescent material.

An edge portion of the first panel may be a polished edge portion and may comprise a reflective coating, such as a metallic coating. The reflective coating at the edge portion of the first panel facilitates reflection of light that has not been absorbed back towards the solar cells for absorption.

The luminescence material may also effectively downshift a wavelength of incident light as the fluorescence radiation has a larger wavelength than the light absorbed by the luminescent material. Incident light may be absorbed by the luminescent material followed by emission of fluorescence radiation in random directions including directions in which the fluorescence radiation is subsequently guided through the first panel. For example, the luminescent material may be arranged to convert incident light in wavelength ranges in which the solar cells have a relatively low external quantum efficiency (EQE) into the fluorescence radiation in the higher-EQE ranges.

The solar cells may be positioned between a portion of the frame and the first panel in the proximity of an edge of the first panel. The solar cells may cover portions of the frame structure.

The solar cells may be spaced apart or may be in contact with the first panel. The solar cells may be positioned parallel to, and may be directly facing, the second major surface of the first panel. Alternatively, the solar cells may be positioned at an inclined orientation relative to the second major surface of the first panel. For example, the solar cells may be inclined at an angle smaller than 90°, smaller than 70°, smaller than 50°, smaller than 30° or smaller than 10°.

The plurality of solar cells may include a first series of solar cells and the window may comprise a second series of solar cells. The second series of solar cells may be positioned along the first series of the solar cells and may be positioned adjacent the first series of the solar cells. The solar cells of the second series may or may not have the same orientation as the and the solar cells of the first series. The solar cells of the second series may be positioned parallel to, and may be directly facing, the second major surface of the first panel. Alternatively, the solar cells of the second series may be positioned at an inclined orientation relative to the second major surface of the first panel. For example, the solar cells of the second series may be inclined at an angle smaller than 90°, smaller than 70°, smaller than 50°, smaller than 30° or smaller than 10° or smaller.

In one specific embodiment the solar cells of the first series are oriented parallel to the second major surface of the first panel and are positioned between portions of the frame and the first panel. In this embodiment the solar cells of the second series are directly adjacent the solar cells of the first series and are positioned in an orientation that is inclined relative to the first panel. These inclined solar cell modules will then be facing the internal air-space of window at essentially 4 different geometric orientations with respect to the incoming sunlight-thus improving energy capture by window when Sun is moving across the sky.

The first panel portion and the second panel portion may comprise a suitable glass or polymeric material. In one specific embodiment the first and second panel portions comprise ultra-clear low-iron glass.

The window may further comprise a second panel positioned parallel to the first panel. The second panel may have a major surface that faces a space that is outside of the window, such as an interior space of the building or structure when the window is mounted to the building or structure. The frame and the solar cells may be positioned between the first panel and the second panel.

The second panel may also comprise a coating such as a low-emissivity coating providing high reflectivity for wavelengths between approximately 300 to 420 nm, and optionally also for approximately 750 to 1000 nm and larger wavelengths. The coating enables reflection of emitted fluorescence radiation and scattered incident light in a spectrally selective manner.

The solar cells are typically silicon-based, but may alternatively also comprise CuInSe₂, CIGS or CIS, GaAs, CdS or CdTe.

The window may be arranged such that a central area of the window is transparent for at least the majority of visible light is at least 5, 10, 15, 20, 50, 100 or even 500× larger than an area of the panel at which the series of the solar cells are positioned.

The central area that is transparent for at least the majority of visible light may be transmissive for at least 60%, 70%, 80%, 90% or even at least 95% or visible light incident of the receiving surface at normal incidence.

The invention will be more fully understood from the following description of specific embodiments of the invention. The description is provided with reference to the accompanying drawings.

### BRIEF DESCRIPTION OF THE DRAWINGS

FIG. 1 is a schematic front view of a window for a building or structure in accordance with an embodiment of the present invention; and

FIG. 2 is a schematic cross-sectional representation of a portion of the window for a building or structure in accordance with an embodiment of the present invention.

### DETAILED DESCRIPTION OF EMBODIMENTS

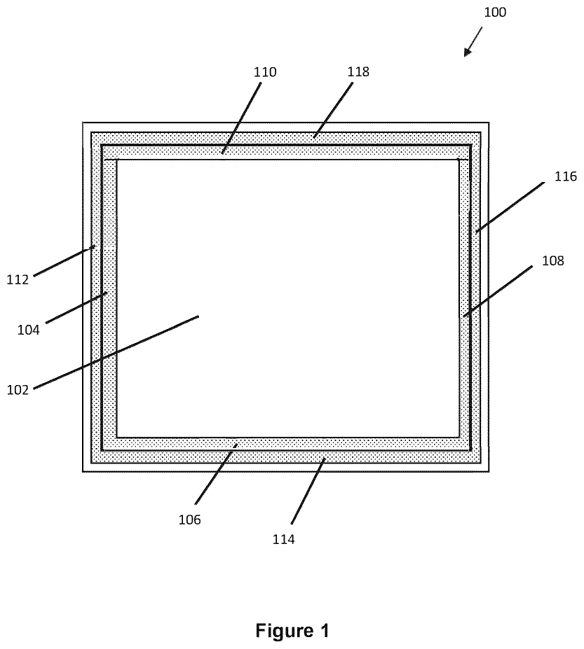

Referring initially to FIG. 1, there is shown a schematic top view of a window 100 in accordance with an embodiment of the present invention. The window 100 comprises a first panel 102 and four first series of solar cells 104 106, 108, 110 positioned in proximity to respective edges of the first panel 102. The four first series of solar cells 104 106, 108, 110 directly face a light receiving surface of the first panel 102 panel and together surround an area of the panel that is at least largely transmissive for light. The window 100 also comprises four second series of solar cells 112, 114, 116 and 118. The first series of solar cells 104 106, 108, 110 are in this embodiment oriented parallel to the first panel 102 and the second series of solar cells 112, 114, 116 and 118 are positioned at an inclined orientation relative to the first panel 102. The window 100 also comprises a frame structure which is positioned behind the first series of solar cells 104 106, 108, 110. The frame structure directly or indirectly supports the first panel. Further, the window 100 comprises a second panel (not shown) which is opposite and oriented parallel to the first panel 102 and in use exposed to an inner space of the building or structure to which the window 100 is mounted.

The first panel 102 is transmissive for at least 90% of incident visible light. The first series of solar cells 104 106, 108, 110 and the second series of solar cells 112, 114, 116 and 118 are only positioned at an edge region of the first panel 102 such that only at the edge region of the first panel 102 the transmission of incident light is obstructed by the solar cells.

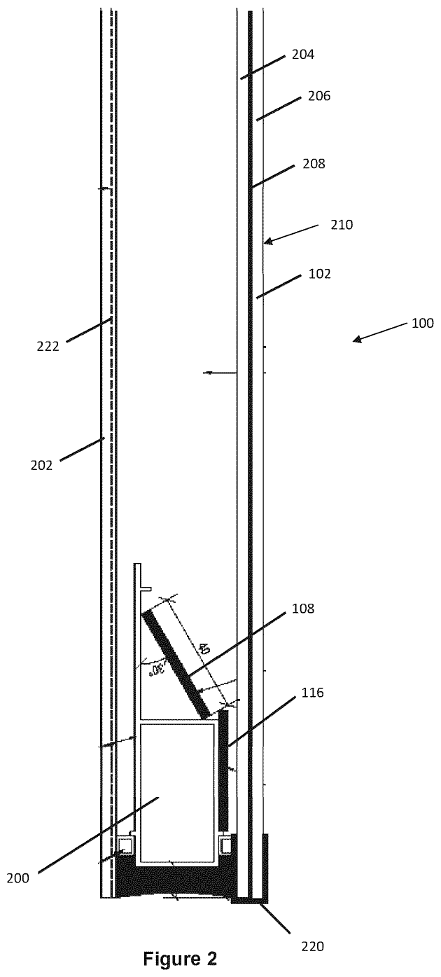

Referring now to FIG. 2, the window 100 is described in further detail. Like features are given like reference numerals. The solar cells 108 and 116 of the first and second series of solar cells, respectively, are supported by a frame 200. FIG. 2 also shows the second panel 202 of the window 100.

The first panel 102 has a first major surface 210 which is exposed to a space that is outside of the window 100 and which is the surface at which the window receives direct sunlight light originating from outside a building or structure when the window is mounted to the building or structure.

The first panel 102 comprises parallel first and second panel portions 204, 206 which are laminated together using a sandwich layer in the form of polyvinyl butyral (PVB) layer 208. In this embodiment the panel portions 204, 206 are ultra-clear low-iron glass sheets having a thickness of 4 mm and the PVB layer 208 has in this embodiment a thickness of 0.76 mm or 1.52 mm.

The window 100 further comprises a luminescent material which in this embodiment is embedded in the PVB layer 208. In a variation of the described embodiment the PVB layer 208 may also comprise two component layers which may each comprise respective luminescent materials and/or respective luminescent material concentrations.

The luminescent material in the PVB layer 208 absorbs incoming light and emits fluorescence radiation in random directions. A portion of the emitted fluorescence radiation is directed within the first panel 102 by total internal reflection towards an edge region of the first panel 102 where a portion of the light can be absorbed by the solar cells (such as solar cells of the series 108, 116) for generation of electricity. As the first panel 102 directly faces a space that is outside of the window, the luminescence material is positioned near the outside of the window (the thickness of the panel portion 206 is only 4 mm) thereby avoiding intensity losses that incident light would otherwise experience when transmitting through multiple panels, such as multiple glass panels, before reaching the luminescent material.

The first panel 102 further comprises at the edge a reflective coating 220, such as a coating formed from a metallic material or paint/spray containing reflective particles. The reflective coating 220 is located on a polished edge (˜90 degree cut) of the first panel 102. The reflective coating 220 facilitates reflection of light that has not been absorbed by the solar cells, to propagate back towards the solar cells for absorption.

The luminescent material also effectively down-shifts a wavelength of some of the incident light. For example, the luminescent material may be arranged to convert incident light in wavelength ranges in which the solar cells have a relatively low external quantum efficiency (EQE), such as eg 300 mm-˜ 490 nm for a silicon-based solar cell, into the fluorescence radiation in the higher-EQE ranges (˜800-1000 nm, and/or also ˜600-800 nm).

In the described embodiment the solar cells of the series of solar cells (such as series 108, 116) are positioned between a portion of the frame 200 and the first panel 102 in an edge region of the first panel 102. The solar cells cover the majority of the frame 200 as seen through the first panel 102.

In this embodiment the solar cells of the first series (104, 106, 108 and 110) and second series (112, 114, 116 and 118) are spaced apart from the first panel 102. The solar cells of the second series 112, 114, 116 and 118 are positioned parallel to the first panel 102. The solar cells of the first series 104, 106, 108 and 110 are positioned at an inclined orientation relative to the first panel 102. In this embodiment the solar cells of the first series 104, 106, 108 and 110 are positioned at an angle of 30° relative to the first panel 102.

As the solar cells of the first series 104, 106, 108 and 110 are positioned at an inclined orientation relative to the first panel 102, these solar cells receive both solar light from a direction of incidence and light that is scattered or reflected at surfaces or interfaces within the window 100. The inclined solar cells of the first series 104, 106, 108 and 110 are also less likely to be in a position of direct geometric shading when the framed window is exposed to solar light, which facilitates improved uniformity of irradiation intensity between the solar cells of the first series 104, 106, 108 and 110, which improves and electric output of the window 100.

The second panel 202 also comprises a low-emissivity coating 222 which enables reflection of incident sunlight, emitted fluorescence radiation and scattered incident light in a spectrally selective manner. In this embodiment the low-emissivity coating 222 is arranged to have a high reflectivity for wavelengths between 300 to approximately 420 nm, and also for approximately 750 to approximately 1000 nm.

A person skilled in the art will appreciate that in alterative embodiments the solar cells of the first series 104, 106, 108 and 110 may be inclined by another suitable angle. Further, the solar cells of the second series 112, 114, 116 and 118 may alternatively be positioned at an inclined angle relative to the first panel 102. Further, in another alternative embodiment the window 100 may not comprise the solar cells of the first series 104, 106, 108 and 110. The person skilled in the art will also appreciate that the provided dimensions are only examples and various other dimensions are within the scope of embodiments of the invention.

Any discussion of the background art throughout this specification should in no way be considered as an admission that such background art is prior art, nor that such background art is widely known or forms part of the common general knowledge in the field in Australia or worldwide.

1. A window for a building or structure, the window comprising:
a first panel being at least largely transmissive for visible light and having opposite first and second major surfaces, the first major surface being a light receiving surface, the first panel comprising a luminescent material and/or a light scattering material;
a plurality of solar cells facing the second major surface of the first panel and being positioned along and in proximity of an edge of the first panel; and
a frame supporting the first panel directly or indirectly;
wherein the first major surface of the first panel is directly exposed to a space that is exterior to the window.

2. The window of claim 1, wherein the plurality of solar cells faces the second major surface of the first panel directly.

3. The window of claim 1, wherein the first panel is positioned such that light originating from outside of the building or structure is received by the receiving surface of the first panel before transmitting to other portions of the window.

4. The window of claim 1, wherein the first panel comprises parallel first and second panel portions which are laminated together and wherein the first major surface is a surface of the first panel portion and the second major surface is a surface of the second panel portion.

5. The window of claim 4, wherein the first and second panel portions are laminated together using a sandwich layer comprising polyvinyl butyral (PVB).

6. The window of claim 1, wherein the first panel comprises the luminescent material.

7. The window of claim 6, wherein the luminescent material is arranged to convert incident light in wavelength ranges in which the solar cells have a relatively low external quantum efficiency (EQE) into fluorescence radiation in higher-EQE wavelength ranges.

8. The window of claim 5 wherein the first panel comprises the luminescent material, and wherein the luminescent material is embedded in the PVB.

9. The window of claim 1, wherein an edge portion of the first panel comprises a reflective coating, such as a metallic coating.

10. The window of claim 1, wherein the solar cells are positioned between a portion of the frame and the first panel in the proximity of an edge of the first panel.

11. The window of claim 1, wherein the solar cells cover portions of the frame structure.

12. The window of claim 1, wherein the solar cells are spaced apart from the first panel.

13. The window of claim 1, wherein the solar cells are positioned parallel to, and are directly facing, the second major surface of the first panel.

14. The window of claim 1, wherein the solar cells are positioned at an inclined orientation relative to the second major surface of the first panel.

15. The window of claim 1, wherein the plurality of solar cells includes a first series of solar cells and the window comprises a second series of solar cells and wherein the second series of solar cells is positioned along the first series of the solar cells and is positioned adjacent the first series of the solar cells.

16. The window of claim 15, wherein the solar cells of the second series have a same orientation as the solar cells of the first series and are positioned parallel to, and are directly facing, the second major surface of the first panel.

17. The window of claim 15, wherein the solar cells of the second series do not have the same orientation as the solar cells of the first series and are positioned at an inclined orientation relative to the second major surface of the first panel.

18. The window of claim 17, wherein the solar cells of the first series are oriented parallel to the second major surface of the first panel and are positioned between portions of the frame and the first panel and wherein the solar cells of the second series are directly adjacent the solar cells of the first series and are positioned in an orientation that is inclined relative to the first panel.

19. The window of claim 1, further comprising a second panel positioned parallel to the first panel, and wherein the frame and the solar cells are positioned between the first and second panels.

20. The window of claim 19, wherein the second panel comprises a coating such as a low-emissivity coating providing high reflectivity for wavelengths between 300 to approximately 420 nm, and typically also for approximately 750 to approximately 1000 nm and/or above.

21. (canceled)
